(19) United States
(12) Patent Application Publication
(10) Pub. No.: US 2005/0102157 A1
(43) Pub. Date: May 12, 2005

(54) Project managing system, project managing method and project managing program

(75) Inventors: Shiro Soma, Tokyo (JP); Takumi Hasegawa, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/984,828

(22) Filed: Nov. 10, 2004

(30) Foreign Application Priority Data
Nov. 12, 2003 (JP) 2003-382732

(51) Int. Cl. G06F 17/60

(52) U.S. Cl. 705/1; 705/9

(57) ABSTRACT

In a project managing system and a project managing method, reports of daily jobs of a developing designer are produced in a fixed format and information is automatically registered during daily jobs to thereby reducing load of jobs imposed on the developing designer. Progress data and knowledge data are inputted by a progress data input section and a knowledge data input section which have fixed formats. The progress data is accumulated in a progress managing database and the knowledge data is accumulated in a knowledge database. Using a progress data display and a knowledge data display, the progress data and the knowledge data are displayed.

### BACKGROUND OF THE INVENTION

1. Field of the Invention

The present invention relates to a project managing system and a project managing method which manages a project for product development and which supports use of knowledge in the project.

2. Description of the Prior Art

Conventional project managing systems utilize top-down project management in which each development and design line table is determined using a product development and delivery table such that indications are issued from a product manager via a person in charge of devices to each designer as shown in FIG. 9. To manage a project, it is required that information of progress of a job is appropriately classified to be fed to the project managing system in an actual site of development and design. Also, in a knowledge managing system, it is necessary that for knowledge distributed according to managing levels of, for example, notes of individual persons, the respective designers input and register information to a database or the like so that the designers share the knowledge as shown in FIG. 10. To retrieve information, it is required for each designer to actively conduct a retrieval operation by himself or herself to obtain the information.

For project management or know-how management, the system presents a guide according to a progress state of a project. Assume that the management know-how given as a guide to support the project management includes the fixed contents registered when a system to support the project is installed. If the project is development of a product with rapid technical innovation, the management know-how becomes old-fashioned or out-of-date in a short period of time. To overcome the difficulty, for example, Japanese Patent Laid-Open Publication Ser. No. 2003-91627 describes a technique for use at occurrence of a problem in a project to overcome the difficulty of appropriate recognition and description of a specific progress state of the project at the point of occurrence of the problem. In this technique to support project management, when a progress state data calculating unit receives a specification of a project and a calculation point of progress state data, the calculating unit retrieves management know-how from a know-how database at the point of time and presents the know-how. Resultantly, the management know-how corresponding to the progress state of the project can be appropriately set as a shared item at a high speed.

However, the conventional configuration and the example of the prior art are attended with problems as below.

In the project managing system of the prior art, since a development and design delivery date is determined using a product development and delivery line table in a top-down way, it is difficult to reflect the job progress state in the development and design site. Additionally, the project managing information and the knowledge information are not used in daily jobs of developing designers in charge of development and design in the project. Therefore, at installation of a project or knowledge managing system, the developing designer is required to input, in addition to information for the development and design job, information necessary for the system to manage the project and the knowledge. This increases load imposed on the developing designers and leads to a vicious circle in which the product development is delayed and the job for the project management and the knowledge management is also delayed. That is, the job to appropriately classify, for the project management, information and to input the information to the project managing system in the development and design site is essential in the system. This consequently increases the load imposed on the developing designers. For knowledge management, it is also necessary to input and register information to a database or the like to shape knowledge, and hence the load of the designer is increased in the system. For information retrieval, each designer is required to obtain information by himself or herself like in a top-down project managing system. This leads to a problem of increase of load imposed on the developing designer. To implement project management or knowledge management with high precision, maintenance of original data is required and hence there arises a problem of complexity of the operation procedure. Although the knowledge management is conducted using a database, if description methods are not systematically unified, there occurs a situation in which only the person who has described associated information can understand the contents of the information.

In the conventional example described in Japanese Patent Laid-Open No. 2003-91627, an operator of a terminal inputs management know-how to the know-how database. That is, the data is not automatically registered to the database, and hence the load of input operation of the system user cannot be reduced. For the information retrieval, whether or not target management know-how is present is determined through operation of the operator from his/her the terminal. That is, the retrieval is not automatically conducted and hence there exists a problem that the load imposed on the system user cannot be mitigated.

### SUMMARY OF THE INVENTION

It is therefore an object of the present invention to provide a project managing system for managing and supporting a project for product development. The system includes a progress managing database for storing therein progress data representing progress of a project, a knowledge database for storing therein knowledge data, a progress data input section having a predetermined format for inputting the progress data, a knowledge data input section having a predetermined format for inputting the knowledge data, a progress data accumulating section for accumulating in the progress managing database the progress data inputted by the progress data input section, a knowledge data accumulating section for accumulating in the knowledge database the knowledge data inputted by the knowledge data input section, a progress data display section for displaying thereon the progress data stored in the progress managing database, and a knowledge data display section for displaying thereon the knowledge data stored in the knowledge database. The present invention has also an object of providing, in addition to the project managing system, a project managing method in which thanks to the configuration of the project managing system, a daily report and a weekly report of a developing designer and reports of daily jobs such as notes of problems are produced according to fixed formats. The formats include items to input information about the project management and the knowledge management. During daily jobs of developing designers, information and knowledge necessary for the project management are extracted to be automatically registered to a database. This reduces load of jobs imposed on the developing designers. Thanks to the unified formats, information items become homogenous and can be managed in a unified or centralized fashion.

In accordance with a first aspect of the present invention, there is provided a project managing system for managing and supporting a project for product development including a progress managing database for storing therein progress data representing progress of a project, a knowledge database for storing therein knowledge data, a progress data input section having a predetermined format for inputting the progress data, a knowledge data input section having a predetermined format for inputting the knowledge data, a progress data accumulating section for accumulating in the progress managing database the progress data inputted by the progress data input section, a knowledge data accumulating section for accumulating in the knowledge database the knowledge data inputted by the knowledge data input section, and a progress data display section for displaying thereon the progress data stored in the progress managing database.

In accordance with a second aspect of the present invention, there is provided a project managing system for managing and supporting a project for product development including a progress managing database for storing therein progress data representing progress of a project, a progress data input section having a predetermined format for inputting the progress data, a progress data accumulating section for accumulating in the progress managing database the progress data inputted by the progress data input section, and a progress data display section for displaying thereon the progress data stored in the progress managing database.

In accordance with a third aspect of the present invention, there is provided a project managing system for managing and supporting a project for product development including a knowledge database for storing therein knowledge data, a knowledge data input section having a predetermined format for inputting the knowledge data, and a knowledge data accumulating section for accumulating in the knowledge database the knowledge data inputted by the knowledge data input section.

In accordance with a fourth aspect of the present invention, in a project managing system of the first or second aspect, the format to input the progress data is a format adaptive to a database configuration of the progress managing database, and the progress data accumulating section automatically accumulates in the progress managing database the progress data inputted using the format.

In accordance with a fifth aspect of the present invention, in a project managing system of the first, second, or fourth aspect, the format to input the progress data is adopted for a document in a daily job.

In accordance with a sixth aspect of the present invention, in a project managing system of the fifth aspect, the format to input the progress data is adopted for a job report.

In accordance with a seventh aspect of the present invention, in a project managing system of the first or third aspect, the format to input the knowledge data is a format adaptive to a database configuration of the knowledge database and the knowledge data accumulating section automatically accumulates in the knowledge database the knowledge data inputted using the format.

In accordance with an eighth aspect of the present invention, in a project managing system of the first, third, or seventh aspect, the format to input the knowledge data is adopted for a document in a daily job.

In accordance with a ninth aspect of the present invention, in a project managing system of the eighth aspect, the format to input the knowledge data is adopted for a job report.

In accordance with a tenth aspect of the present invention, a project managing system of the first, third, seventh, eighth, or ninth aspect further includes a judge section for determining whether or not a predetermined keyword included in data inputted by the progress data input section and/or data inputted by the knowledge data input section is included in the knowledge data accumulated in the knowledge database and a notifying section for notifying the knowledge data which is accumulated in the knowledge database and which includes the predetermined keyword to a person having inputted data using the progress data input section and/or the knowledge data input section.

In accordance with an eleventh aspect of the present invention, in a project managing system of the first, third, seventh, eighth, ninth, tenth, or 11th aspect, the knowledge data is document data of a document.

In accordance with a twelfth aspect of the present invention, in a project managing system of the tenth, or 11th aspect, the notifying section is electronic mail.

In accordance with a thirteenth aspect of the present invention, in a project managing system according to one of the first and second aspects and the fourth to 12th aspects, the progress managing database further stores therein schedule data indicating a schedule of progress of a project. The system further includes a progress state display section for displaying the schedule data stored in the progress managing database and the progress data, the schedule data and the progress data enabling to recognize discrepancy between the schedule and an actual result of the project.

In accordance with a fourteenth aspect of the present invention, there is provided a project managing method of managing and supporting a project for product development. The method includes the steps of storing progress data representing progress of a project in a progress managing database, storing knowledge data representing a progress of a project in a knowledge database, inputting the progress data using a progress data input section having a predetermined format, inputting the knowledge data using a knowledge data input section having a predetermined format, accumulating in the progress managing database by a progress data accumulating section the progress data inputted by the progress data input section, accumulating in the knowledge database by a knowledge data accumulating section the knowledge data inputted by the knowledge data input section, and displaying by a progress data display section the progress data stored in the progress managing database.

In accordance with a fifteenth aspect of the present invention, a project managing method in accordance with the 14th aspect further includes the steps of determining by a judge section whether or not a predetermined keyword included in data inputted by the progress data input section and/or data inputted by the knowledge data input section is included in the knowledge data accumulated in the knowledge database, and notifying by a notifying section the knowledge data which is accumulated in the knowledge database and which includes the predetermined keyword to a person having inputted data using the progress data input section and/or the knowledge data input section.

In accordance with the present invention, there is provided a project managing system for managing and supporting a project for product development. The system includes a progress managing database for storing therein progress data representing progress of a project, a knowledge database for storing therein knowledge data, a progress data input section having a predetermined format for inputting the progress data, a knowledge data input section having a predetermined format for inputting the knowledge data, a progress data accumulating section for accumulating in the progress managing database the progress data inputted by the progress data input section, a knowledge data accumulating section for accumulating in the knowledge database the knowledge data inputted by the knowledge data input section, a progress data display section for displaying thereon the progress data stored in the progress managing database, and a knowledge data display section for displaying thereon the knowledge data stored in the knowledge database. Thanks to the configuration of the project managing system, it is possible that a daily report and a weekly report of a developing designer and reports of daily jobs such as notes of problems are produced according to fixed formats. The formats include items to input information about the project management and the knowledge management. During daily jobs of developing designers, information and knowledge necessary for the project management are extracted to be automatically registered to a database. This can reduce load of jobs imposed on the developing designers. Thanks to the unified formats, information items become homogenous and can be managed in a unified or centralized fashion.

In accordance with the present invention, there can be constructed a project managing system in which a daily report and a weekly report of a developing designer and reports of daily jobs such as notes of problems are produced according to fixed formats. The formats include items to input information about the project management and the knowledge management. During daily jobs of developing designers, information and knowledge necessary for the project management are extracted to be automatically registered to a database. This reduces load of jobs imposed on the developing designers. Thanks to the unified formats, information items become homogenous and can be managed in a unified or centralized fashion. That is, there can be configured a project managing system for managing and supporting a project for product development by disposing a progress managing database for storing therein progress data representing progress of a project, a knowledge database for storing therein knowledge data, a progress data input section having a predetermined format for inputting the progress data, a knowledge data input section having a predetermined format for inputting the knowledge data, a progress data accumulating section for accumulating in the progress managing database the progress data inputted by the progress data input section, a knowledge data accumulating section for accumulating in the knowledge database the knowledge data inputted by the knowledge data input section, a progress data display section for displaying thereon the progress data stored in the progress managing database, and a knowledge data display section for displaying thereon the knowledge data stored in the knowledge database.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing a configuration of an embodiment of a project managing system in accordance with the present invention;

FIG. 2 is a diagram schematically showing an outline of a project managing system;

FIG. 3 is a table showing a format of a daily report;

FIG. 4 is a table showing a format of an evaluation item list;

FIG. 5 is a table showing a format of a weekly report;

FIG. 6 is a table showing a display example of a progress managing screen;

FIG. 7 is a flowchart showing operation of progress management;

FIG. 8 is a flowchart showing operation of knowledge management;

FIG. 9 is a schematic diagram showing a configuration of a conventional embodiment of a progress managing system; and

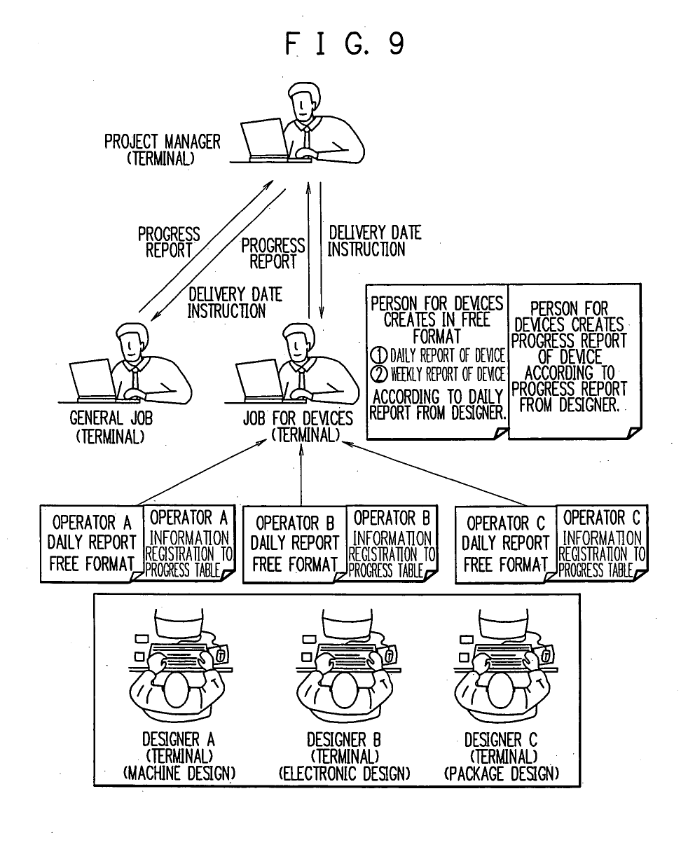

FIG. 10 is a diagram schematically showing a configuration of a conventional embodiment of a knowledge managing system.

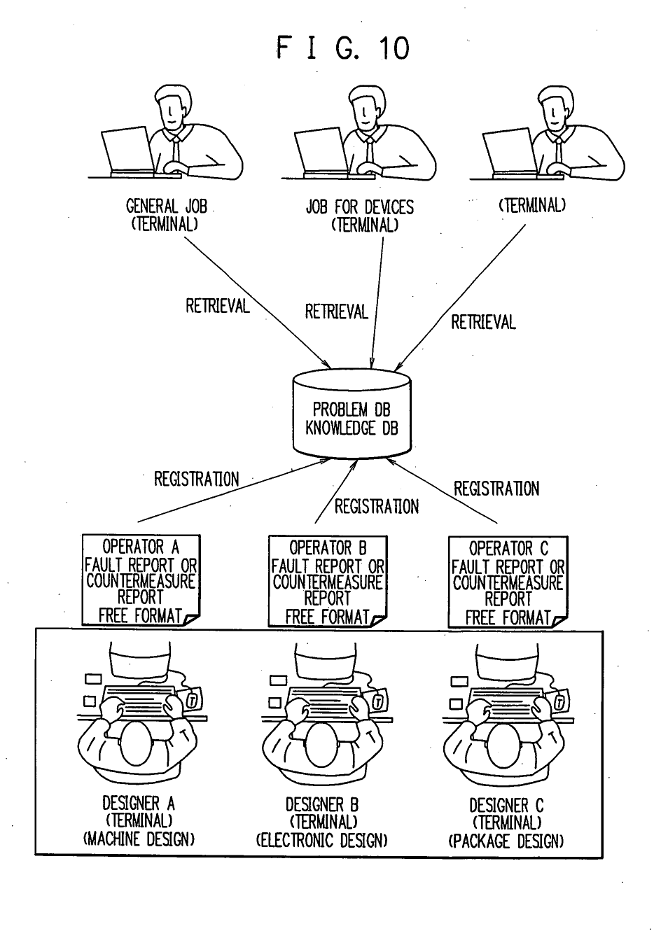

### DESCRIPTION OF THE EMBODIMENTS

Referring next to the drawings, description will be given of a configuration and operation of the first embodiment in accordance with the present invention.

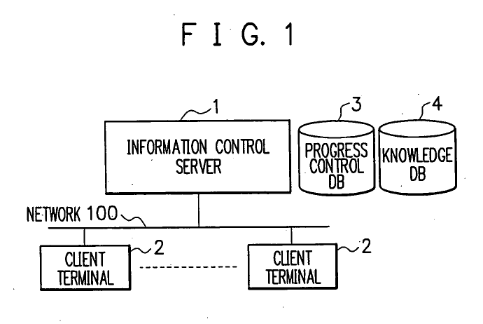

FIG. 1 shows a configuration of a project managing system for a device developing project in the embodiment. The system includes an information managing server 1 and client terminals 2 connected via a network 100 to the server 1.

The server 1 includes a progress managing database 3 to store progress data and a knowledge database 4 to store knowledge data.

The progress managing database 3 is disposed for persons such as a member of the project and a product manager to recognize a progress state of the project. The database 3 stores items such as a job item, an operator's or member's name, a completion date, a number of items, a number of completed items, and a progress rate.

The knowledge database 4 is a database for each member of the project and a product manager to manage knowledge to be used to solve problems occurring in the project. The database 4 stores therein items such as a problem occurrence step in which a problem occurs, a date of occurrence, a state of progress inspection, a cause, a disposition, and a preventive countermeasure.

The client terminal 2 is an information processor installed in an associated site of a factory or the like to be operated by each designer, each member, or a product manager. The terminal 2 includes a communicating function for wired or wireless communication and is, for example, a personal computer, a cellular phone, a personal digital assistant, or a notebook personal computer.

The network 100 is an arbitrary network, for example, a local area network (LAN), a wide area network (WAN), or the internet.

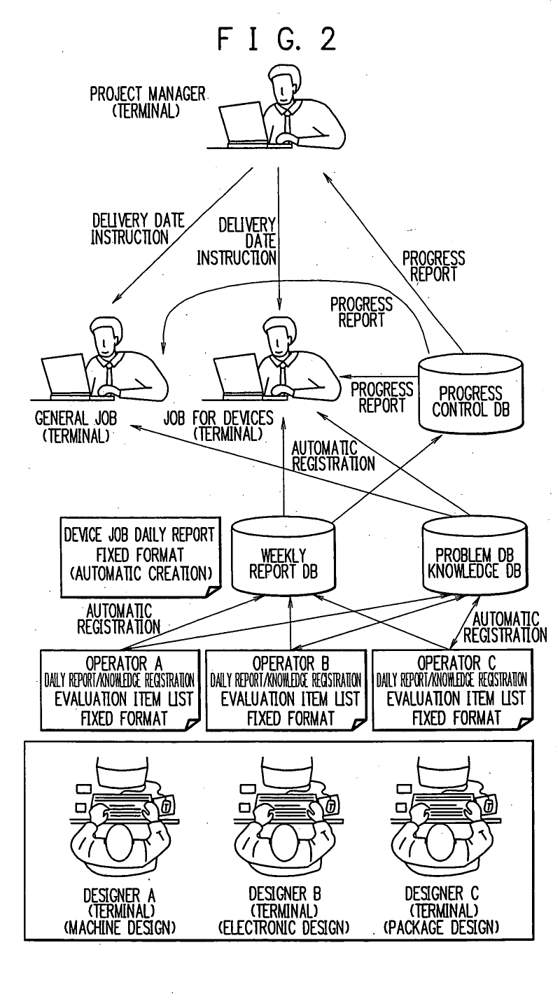

FIG. 2 shows an outline of a project managing system in the embodiment. Designer A in charge of device or machine design, designer B for electric design, and designer C for package design respectively operate the client terminals 2 to input daily report data using a fixed format for the daily report, knowledge data using a fixed format for knowledge registration, and evaluation data using a fixed format for the evaluation item list.

The daily report indicates a job report including a daily progress state of a job. The knowledge includes knowledge, methods, and the like to solve problems taking place during the developing project and is a concept including management know-how associated with a progress state. For a problem, an item of knowledge is obtained in many cases from experience of solving a similar problem in the past. In the evaluation item list, for each person in charge, an evaluation person other than the person in charge is set for each evaluation item. Using the list, an event in which confirmation is not conducted due to wrong understanding of the person in charge is prevented and assignment of responsibility to the person in charge is clarified.

The device job daily report is a comprehensive daily report regarding the overall device development. The information managing server 1 automatically generates the report using daily report data which is inputted from each designer and which is sent via the network 100.

The weekly report database is disposed in the information managing server 1. Weekly report data is automatically registered to the database. Using the daily report data, the server 1 automatically creates weekly report data regarding a weekly progress state of the project.

The problem database is disposed in the information managing server 1. Problem data is automatically registered to the database. Using the daily report data, the server 1 automatically creates problem data regarding problems exerting influence on the progress of the developing project.

To the knowledge database 4, a knowledge data accumulator may automatically register knowledge data. Or, the database 4 may be substantially equal to the problem database.

To the progress managing database 3, a progress data accumulator may automatically register data from the weekly report database. Or, the progress data accumulator may directly register to the database 3 the daily report data or the evaluation data which is inputted from each designer and which is received via the network 100.

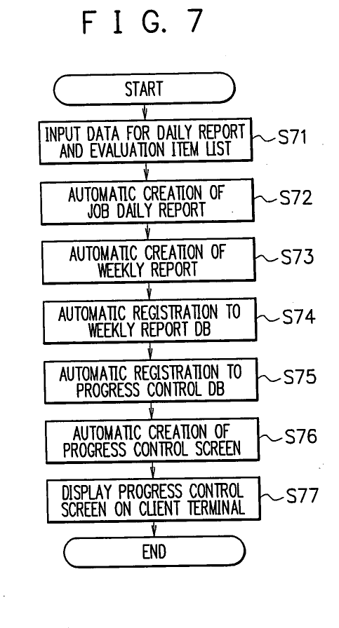

Referring now to the flowchart of FIG. 7, description will be given of operation for the progress control of the project managing system in the embodiment constructed as above.

The leader of the project such as a project manager creates a general line table using a product delivery line table and notifies a delivery schedule to the person in charge of devices or registers by himself or herself the delivery schedule to the progress managing database. Designer A for device design, designer B for electric design, and designer C for package design input daily report data from the respective client terminals 2 using the daily report fixed format and evaluation data using the evaluation item list fixed format (step S71).

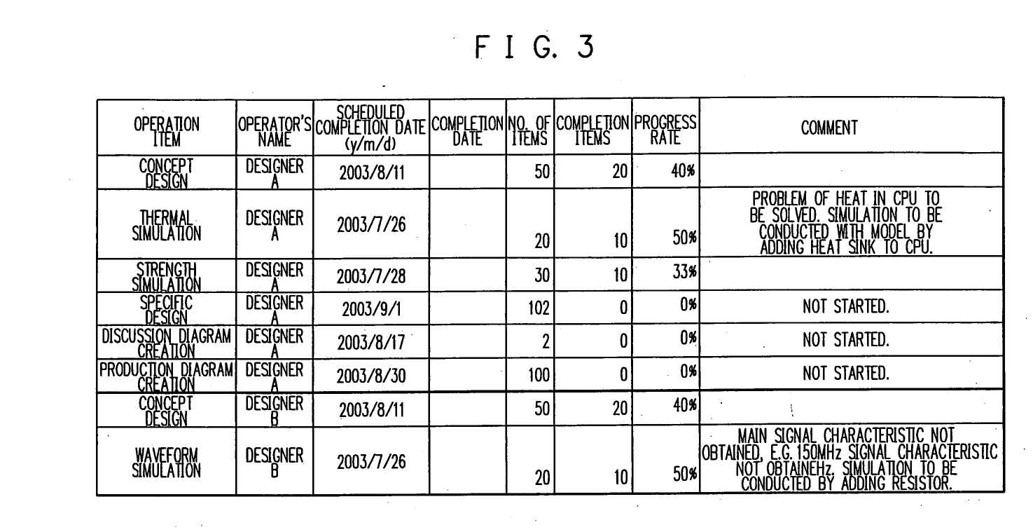

For example, as shown in FIG. 3, the fixed format for the daily report may be constructed as a table in which required items are described. The items include essential items such as a job item, an operator's name, a scheduled completion date, a number of items, and a number of completed items and optional items including a completion date and a comment. The format may allow registration of a plurality of keywords. Thanks to the fixed format, it is possible to obtain homogeneous information items.

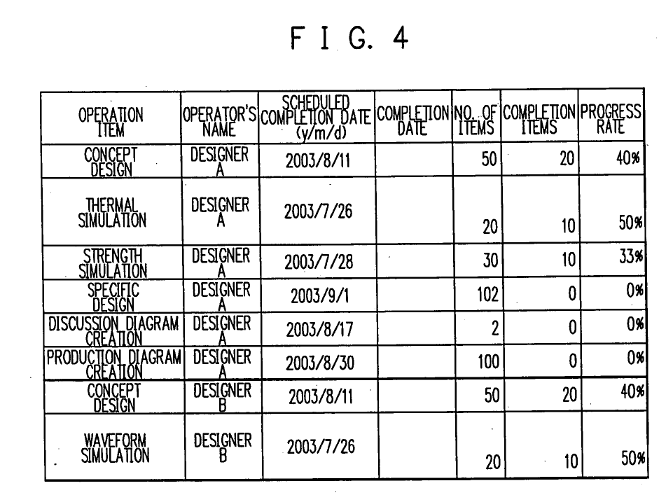

For example, it is also possible as shown in FIG. 4 that the fixed format for the evaluation item list is in the form of a table in which necessary items are described. The items include essential items such as a job item, an operator's name, a scheduled completion date, a number of items, a number of completed items, and a progress rate. A plurality of keywords may be registered to the list. The fixed format makes it possible to attain homogeneous information items.

The information managing server 1 receives the daily report data which is inputted from each designer and which is sent via the network 100 and automatically creates a device job daily report according to the daily report data (step S72). The daily report received via the network 100 may be automatically registered to the weekly report database by the progress data accumulator.

When the daily report data inputted from each designer is received via the network 100, the information managing server 1 automatically generates a weekly report according to the daily report data or the device job daily report (step S73).

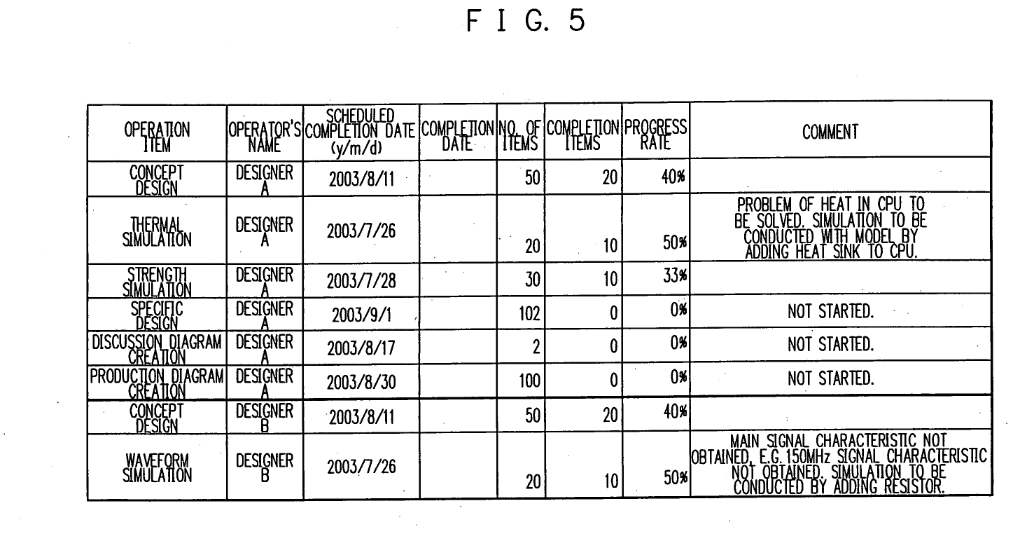

For example, as shown in FIG. 5, the fixed format for the weekly report may be in the form of a table including essential items such as a job item, an operator's name, a scheduled completion date, a number of items, a number of completed items, and a progress rate and optional items including a completion date and a comment. These items may be automatically created according to the daily report data or the evaluation item list data. Thanks to the fixed format, it is possible to obtain homogeneous information items. By automatically generating the items using the daily report data or the evaluation item list data, the reporting job of each designer can be simplified.

Next, the information managing serve 1 automatically registers the weekly report data produced according to the daily report data or the device job daily report to the weekly report database (step S74).

The serve 1 automatically registers the weekly report data produced by the progress data accumulator according to the daily report data or the device job daily report to the progress managing database 3 (step S75).

According to the progress data registered to the database 3, the server 1 automatically creates image data to be displayed on a progress managing screen (step S76).

Using the progress data registered to the database 3, the server 1 displays by a progress data display section the image data for the progress management on a screen such as a display of the client terminal 2 (step S77).

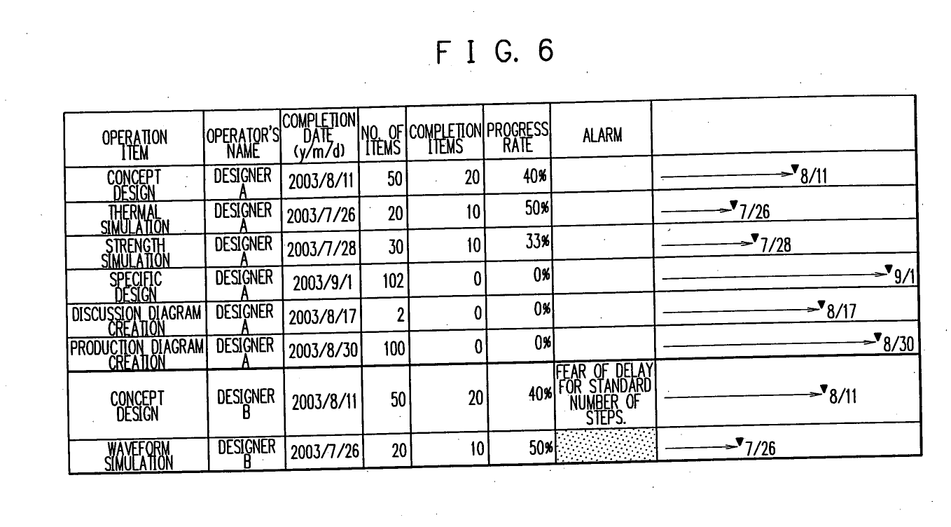

As shown in FIG. 6, the display items on the progress managing screen may include, for example, essential items such as a job item, an operator's name, a scheduled completion date, a number of items, a number of completed items, and a progress rate and an optional item of an alarm. The alarm may be displayed at occurrence of a job delay influencing the overall line table such as a delay caused when a predetermined number of steps is exceeded. The alarm is a symbol, a text, or the like which attracts attention of, for example, an operator or a member of the project.

In the progress managing screen, the progress state may be displayed using arrow marks. This facilitates recognition of the progress state at a glance of the screen image.

The items displayed on the progress managing screen may be automatically generated according to the weekly report data.

The display of the progress managing screen may be in a format in which the general line table determined according to the product delivery schedule and the progress state according to the progress data are managed using a progress managing table. As a result, the discrepancy between the delivery schedule initially indicated by the top-level person such as a project manager and the progress state regarding the bottom-level developing job can be visually recognized.

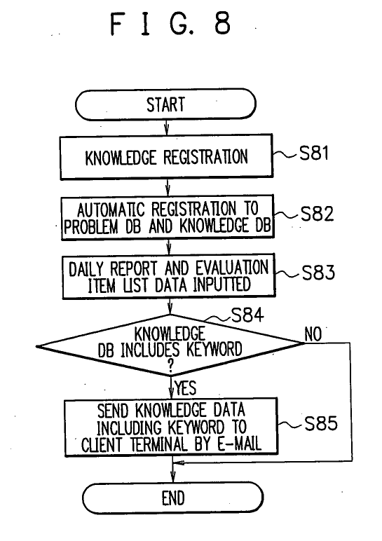

Referring now to the flowchart of FIG. 8, description will be given of operation for knowledge management in the project managing system in the embodiment constructed as above.

Designer A in charge of device design, designer B for electric design, and designer C for package design respectively operate the client terminals 2 to input knowledge data using a fixed format for the knowledge data (step S81).

For example, the fixed format may include essential items such as a step of problem occurrence, a date of occurrence, a state of progress inspection, a cause, and a disposition and an optional item of a preventive countermeasure. Using the format, necessary items are described. In the operation, a plurality of keywords may be registered. Due to the fixed format, homogeneous information items can be obtained.

The information managing server 1 receives the knowledge via the network 100 from each designer and automatically registers by the knowledge data accumulator the knowledge data to the problem database or the knowledge database (step S82).

Device designer A, designer B for electric design, and package designer C respectively operate the client terminals 2 to input daily report data using the fixed format for the daily report and evaluation data using the fixed format for the evaluation item list (step S83).

The server 1 makes a check by a judge section to determine whether or not a keyword in the daily report data or the evaluation data inputted by the designer matches a statement contained in the knowledge data registered to the knowledge database (step S84).

When the check results in a matching state, the information managing server 1 notifies by a notifying section knowledge data containing the keyword to the designer having inputted the daily report data or the evaluation data containing the keyword (step S85). The notifying section may be electronic mail (e-mail) and the knowledge data may be transmitted in the format of an e-mail text or a file attached to an e-mail text. The receivers may be, for example, persons in charge of devices, other designers, and the project manager. As a result, to attain necessary knowledge information, it is not required for each designer to actively retrieve the knowledge. Related information can be automatically notified to persons concerned in a short period of time. The knowledge data may be document data or data such as a table or a diagram.

The information managing server 1 includes a daily report table to store daily report data delivered from the client terminals 2, an evaluation table to store evaluation data inputted therefrom, and a knowledge table to store knowledge data supplied therefrom. The server 1 may include a section which extracts, as a keyword, a word or text data, e.g., a sentence from the text data in the daily report table and the evaluation table to make a search through the knowledge table using the keyword to obtain knowledge data including the keyword.

The server 1 may include an address table storage to store an address table in which user identifier information such as a name of a person associated with the project or a user identifier (ID) and an e-mail address of the user are stored with a correspondence established therebetween. It is also possible that an operator who inputs daily report data and evaluation data from the client terminal 2 also inputs the user identifier information. The server 1 may include a section in which according to the user identifier information received from the client terminal 2, an e-mail address of a person having inputted the daily report data or the evaluation data is identified and knowledge data is sent to the e-mail address.

The server 1 may comprises a computer which comprises a CPU(central processing unit) and another computer units, for example, a storage an ROM(read only memory), an RAM(random access memory)and a display.

And the above-mentioned method executes by the server 1 automatically, that is, the server 1 may execute to read a program for executing to manage and support for product development by the project managing server and execute above-mentioned steps. On the other hand, when the keyword in the daily report data or the evaluation data does not match a statement included in the knowledge data registered to the knowledge database, the processing is terminated.

Although description has been given of the particular embodiments suitable for the present invention, it is to be appreciated that the embodiments can be changed or modified without departing from the scope and spirit of the present invention.

The present invention is applicable also to a knowledge managing system in the service industry.

1. A project managing system for managing and supporting a project for product development, comprising,
a progress managing database for storing therein progress data representing progress of a project;
a knowledge database for storing therein knowledge data;
progress data input part having a predetermined format for inputting the progress data;
knowledge data input part having a predetermined format for inputting the knowledge data;
progress data accumulator for accumulating in the progress managing database the progress data inputted by the progress data input part;
knowledge data accumulator for accumulating in the knowledge database the knowledge data inputted by the knowledge data input part; and
progress data display for displaying thereon the progress data stored in the progress managing database.

2. A project managing system for managing and supporting a project for product development, comprising,
a progress managing database for storing therein progress data representing progress of a project;
progress data input part having a predetermined format for inputting the progress data;
progress data accumulator for accumulating in the progress managing database the progress data inputted by the progress data input part; and
progress data display for displaying thereon the progress data stored in the progress managing database.

3. A project managing system for managing and supporting a project for product development, comprising,
a knowledge database for storing therein knowledge data;
knowledge data input part having a predetermined format for inputting the knowledge data; and
knowledge data accumulator for accumulating in the knowledge database the knowledge data inputted by the knowledge data input part.

4. A project managing system in accordance with claim 1, wherein:
the format to input the progress data is a format adaptive to a database configuration of the progress managing database; and
the progress data accumulator automatically accumulates in the progress managing database the progress data inputted using the format.

5. A project managing system in accordance with claim 2, wherein:
the format to input the progress data is a format adaptive to a database configuration of the progress managing database; and
the progress data accumulator automatically accumulates in the progress managing database the progress data inputted using the format.

6. A project managing system in accordance with claim 1, wherein the format to input the progress data is adopted for a document in a daily job.

7. A project managing system in accordance with claim 2, wherein the format to input the progress data is adopted for a document in a daily job.

8. A project managing system in accordance with claim 5, wherein the format to input the progress data is adopted for a job report.

9. A project managing system in accordance with claim 6, wherein the format to input the progress data is adopted for a job report.

10. A project managing system in accordance with claim 1, wherein:
the format to input the knowledge data is a format adaptive to a database configuration of the knowledge database; and
the knowledge data accumulator automatically accumulates in the knowledge database the knowledge data inputted using the format.

11. A project managing system in accordance with claim 3, wherein:
the format to input the knowledge data is a format adaptive to a database configuration of the knowledge database; and
the knowledge data accumulator automatically accumulates in the knowledge database the knowledge data inputted using the format.

12. A project managing system in accordance with claim 1, wherein the format to input the knowledge data is adopted for a document in a daily job.

13. A project managing system in accordance with claim 3, wherein the format to input the knowledge data is adopted for a document in a daily job.

14. A project managing system in accordance with claim 12, wherein the format to input the knowledge data is adopted for a job report.

15. A project managing system in accordance with claim 13, wherein the format to input the knowledge data is adopted for a job report.

16. A project managing system in accordance with claim 1, further comprising:
judge part for determining whether or not a predetermined keyword included in data inputted by the progress data input part and/or data inputted by the knowledge data input part is included in the knowledge data accumulated in the knowledge database; and
notifying part for notifying the knowledge data which is accumulated in the knowledge database and which includes the predetermined keyword to a person having inputted data using the progress data input part and/or the knowledge data input part.

17. A project managing system in accordance with claim 3, further comprising:
judge part for determining whether or not a predetermined keyword included in data inputted by the progress data input part and/or data inputted by the knowledge data input part is included in the knowledge data accumulated in the knowledge database; and
notifying part for notifying the knowledge data which is accumulated in the knowledge database and which includes the predetermined keyword to a person having inputted data using the progress data input part and/or the knowledge data input part.

18. A project managing system in accordance with claim 1, wherein the knowledge data is document data of a document.

19. A project managing system in accordance with claim 3, wherein the knowledge data is document data of a document.

20. A project managing system in accordance with claim 16, wherein the notifying part is electronic mail.

21. A project managing system in accordance with claim 17, wherein the notifying part is electronic mail.

22. A project managing system in accordance with claim 1, wherein the progress managing database further stores therein schedule data indicating a schedule of progress of a project, the system further comprising
progress state display for displaying the schedule data stored in the progress managing database and the progress data, the schedule data and the progress data enabling to recognize discrepancy between the schedule and an actual result of the project.

23. A project managing system in accordance with claim 2, wherein the progress managing database further stores therein schedule data indicating a schedule of progress of a project, the system further comprising
progress state display for displaying the schedule data stored in the progress managing database and the progress data, the schedule data and the progress data enabling to recognize discrepancy between the schedule and an actual result of the project.

24. A project managing method of managing and supporting a project for product development, comprising the steps of,
storing progress data representing progress of a project in a progress managing database;
storing knowledge data representing a progress of a project in a knowledge database;
inputting the progress data using progress data input part having a predetermined format;
inputting the knowledge data using knowledge data input part having a predetermined format;
accumulating in the progress managing database by progress data accumulator the progress data inputted by the progress data input part;
accumulating in the knowledge database by knowledge data accumulator the knowledge data inputted by the knowledge data input part; and
displaying by progress data display the progress data stored in the progress managing database.

25. A project managing method in accordance with claim 24, further comprising the steps of:
determining by judge part whether or not a predetermined keyword included in data inputted by the progress data input part and/or data inputted by the knowledge data input part is included in the knowledge data accumulated in the knowledge database; and
notifying by notifying part the knowledge data which is accumulated in the knowledge database and which includes the predetermined keyword to a person having inputted data using the progress data input part and/or the knowledge data input part.

26. A program for executing to manage and support for product development by a project managing server, comprising the steps of,
storing progress data representing progress of a project in a progress managing database;
storing knowledge data representing a progress of a project in a knowledge database;
inputting the progress data using progress data input part having a predetermined format;
inputting the knowledge data using knowledge data input part having a predetermined format;
accumulating in the progress managing database by progress data accumulator the progress data inputted by the progress data input part;
accumulating in the knowledge database by knowledge data accumulator the knowledge data inputted by the knowledge data input part; and
displaying by progress data display the progress data stored in the progress managing database.

27. A program for executing to manage and support for product development by a project managing server in accordance with claim 26, further comprising the steps of:
determining by judge part whether or not a predetermined keyword included in data inputted by the progress data input part and/or data inputted by the knowledge data input part is included in the knowledge data accumulated in the knowledge database; and
notifying by notifying part the knowledge data which is accumulated in the knowledge database and which includes the predetermined keyword to a person having inputted data using the progress data input part and/or the knowledge data input part.
